(19) United States
(12) Patent Application Publication
(10) Pub. No.: US 2010/0114608 A1
(43) Pub. Date: May 6, 2010

(54) MEDICAL IMAGE DISPLAY SYSTEM

(75) Inventor: Takanori Ando, Tokyo (JP)

Correspondence Address: CANTOR COLBURN, LLP, 20 Church Street, 22nd Floor, Hartford, CT, 06103, US

(73) Assignee: KONICA MINOLTA MEDICAL & GRAPHIC, INC., Tokyo (JP)

(21) Appl. No.: 12/531,848

(22) PCT Filed: Mar. 3, 2008
(86) PCT No.: PCT/JP2008/053744

§ 371 Date: Sep. 17, 2009

(30) Foreign Application Priority Data
Mar. 23, 2007 (JP) 2007-076965

(51) Int. Cl. G06Q 50/00; G06Q 10/00

(52) U.S. Cl. 705/3

(57) ABSTRACT

Disclosed a medical image display system including: a control member to allow an electric medical record system which manages electric medical record data and a medical image management system which manages a series of various pieces of processing data from photographing to displaying of a medical image to work in concert with each other; and a display member to display a screen to show the electric medical record data and a screen to show the various pieces of processing data wherein the control member changes a displaying status and a display order of the screens displayed in the display member depending on a kind of cooperative operation between the electric medical record system and the medical image management system.

### TECHNICAL FIELD

The present invention relates to an medical image display system, especially a medical image display system which allows an electric medical record system and a medical image management system to work in concert with each other.

### BACKGROUND ART

With a progress of conversion of a medical image into electronic data in a hospital, there has been established a medical image management system which handles a series of processing from photographing to displaying of the medical image. This system stores the medical image data obtained by a photographic device and the like in a large-capacity memory so that a server manages the medical image data to distribute it to a medical image display apparatus installed in each position such as a medical examination room inside a hospital.

There has also been an electric medical record system to replace a medical treatment record of a paper medium in which a doctor wrote a medical treatment process by an electrical system so as to collectively edit/manage the medical treatment record as electronic information to record it in the database.

Such electric medical record system or medical image management system displays various pieces of data as a plurality of screens. For example, as the electric medical record system, an electric medical record system where medical examination information instructed by a selected medical record number is displayed superimposedly on screens displayed in a list in a display member was disclosed (see Patent Document 1). In a medical field, as a technique to superimpose screens, a technique to partly and time-seriously superimpose a plurality of images displayed concurrently was disclosed (see Patent Document 2).

Patent Document 1: Japanese Patent Application Laid-Open Publication No. 2005-174284

Patent Document 2: Japanese Patent Application Laid-Open Publication No. 2006-296882

### DISCLOSURE OF THE INVENTION

### Problem to be Solved by the Invention

The medical image management system and the electric medical record system did not work in concert with each other and each of them was an independent system. Since a screen regarding the medical image management system was displayed on a full screen of a monitor when executing the medical image management system in the middle of execution of the electric medical record system to display an electric medical record screen on the monitor, a screen switching operation by a user was necessary to display the electric medical record screen.

In recent years, by using an overlapping window method, superimposedly displaying various screens displayed by the medical image management system and the electric medical record screen displayed by the electric medical record system is adopted.

Also a technique to allow the medical image management system and the electric medical record system to work in concert with each other so that the electric medical record system calls up various pieces of processing data contained in the medical image management system to display the processing data on a screen has been developed. In this case, when a displaying status of the screen displayed by the medical image management system is a minimization status before being newly called up, the screen remains at the minimization status even when being called up, and looks as if nothing operates.

When a plurality of screens are displayed concurrently, though it is preferred that a screen of most necessary data among the called-up data is displayed at the topmost portion, the screen is sometimes displayed beneath other screens. Especially, since the screen to be displayed at the topmost portion varies depending on a purpose (a kind of cooperative operation) of calling up the screen, if a plurality of screens of the necessary data are merely displayed, a doctor needs to find the screen on which the necessary data is displayed among the plurality of displayed screens so that the operation becomes complicated.

The object of the present invention is to provide a medical image display system which displays screens in the priority order in accordance with the intended purpose.

### Means for Solving the Problem

According to the invention of claim 1, there is provided a medical image display system including: a control member to allow an electric medical record system which manages electric medical record data and a medical image management system which manages a series of various pieces of processing data from photographing to displaying of a medical image to work in concert with each other; and a display member to display a screen to show the electric medical record data and a screen to show the various pieces of processing data; wherein the control member changes a displaying status and a display order of the screens displayed in the display member depending on a kind of cooperative operation between the electric medical record system and the medical image management system.

According to the invention of claim 2, in the medical image display system of claim 1, the various pieces of processing data includes list data of a patient with respect to the medical image which is managed in the medical image management system, and the control member changes the display order of the screen showing the list data of the patient to be topmost and to be front-displayed when the kind of the cooperative operation is a kind which allows the electric medical record system and the list data of the patient included in the various pieces of processing data to work in concert with each other.

According to the invention of claim 3, in the medical image display system of claim 1 or 2, the various pieces of processing data include medical image data of each patient and each examination, and the control member changes the display order of the screen showing the medical image data of the examination of the patient which the electric medical record data indicates to be topmost and to be front-displayed when the kind of the cooperative operation is a kind which allows the examination of the patient which the electric medical record data indicates and the medical mage data of the examination of the patient included in the various pieces of processing data to work in concert with each other.

According to the invention of claim 4, in the medical image display system of claim 3, the control member changes the display order of the screen showing the medical image data of the examination of the patient which the electric medical record data indicates to be topmost and to be front-displayed, and changes the display order of the screen showing older medical image data than the medical image data to be next to the order of the screen showing the medical image data and to be front-displayed, when the kind of the cooperative operation is a kind which allows the examination of the patient which the electric medical record data indicates and the medical image data of the examination of the patient included in the various pieces of processing data to work in concert with each other.

According to the invention of claim 5, in the medical image display system of any of claims 1-4, the various pieces of processing data include report data of each patient and each examination, and the control member changes the display order of the screen showing the report data of the examination of the patient which the electric medical record data indicates to be topmost and to be front-displayed when the kind of cooperative operation is a kind which allows the examination of the patient which the electric medical record data indicates and the report data of the examination included in the various pieces of processing data to work in concert with each other.

### Advantage of the Invention

According to the invention of claim 1, since the displaying status and the display order of the screen displayed in the display member can be changed depending on the kind of the cooperative operation between the electric medical record system and the medical image management system, the screens can be displayed in the priority order in accordance with the intended purpose. Thus, a trouble of switching/finding the screens by a user can be saved, and thereby convenience is enhanced.

According to the invention of claim 2, in addition to the advantage of the invention of claim 1, in the case that the electric medical record system and the list data of the patient included in the various pieces of processing data work in concert with each other, since the screen showing the list data of the patient can be front-displayed in the topmost display order, a user can easily recognize that the screen showing the list data of the patient is displayed, and thereby convenience is enhanced.

According to the invention of claim 3, in addition to the advantage of the invention of claim 1 or 2, in the case that the examination of the patient which the electric medical record data indicates and the medical image data of the examination of the patient included in the various pieces of processing data work in concert with each other, the screen showing the medical image data of the examination of the patient which the electric medical record data indicates can be front-displayed in the topmost display order, a use can be easily recognize that the screen showing the medical image data of the examination of the patient is displayed, and thereby convenience is enhanced.

According to the invention of claim 4, in addition to the advantage of the invention of claim 3, since the screen showing the medical image data of the examination of the patient which the electric medical record data indicates can be front-displayed in the topmost display order, and since the display order of the screen showing older medical image data than the above medical image data can be changed to be next to that of the above screen showing the medical image data and to be front-displayed, a user can easily find the above screen showing the medical image data and the screen to be compared with the above screen, and thereby the trouble of finding the necessary screen can be reduced.

According to the invention of claim 5, in addition to the advantage of the invention of any of claims 1-4, in the case that the examination of the patient which the electric medical record data indicates and the report data of the examination included in the various pieces of processing data work in concert with each other, since the screen showing the report data of the examination of the patient which the electric medical record data indicates can be front-displayed in the topmost display order, a user can easily recognize that the screen showing the report data of the examination of the patient, and thereby convenience is enhanced.

### BRIEF DESCRIPTION OF THE DRAWINGS

FIG. 1 is a drawing showing a system configuration of a medical'image display system according to this embodiment.

FIG. 2 is a drawing showing a configuration of a medical image management apparatus.

FIG. 3 is a drawing showing a configuration of a medical image display apparatus.

FIG. 4 is a drawing showing various screen examples displayed in a monitor contained in a display section.

FIG. 5 is a main flowchart of screen displaying status changing processing according to this embodiment.

FIG. 6 is a flowchart of the screen displaying status changing processing in a patient-examination-related cooperation.

FIG. 7 is a flowchart of the screen displaying status changing processing in an image-related cooperation.

FIG. 8 is a flowchart of the screen displaying status changing processing in a report-related cooperation.

FIG. 9 is a drawing showing an example of a screen display order depending on a kind of cooperative operation by executing the screen displaying status changing processing according to this embodiment.

### BEST MODE TO CARRY OUT THE INVENTION

Hereinafter, an embodiment of the present invention will be explained in detail with reference to the drawings.

Firstly, a configuration will be explained.

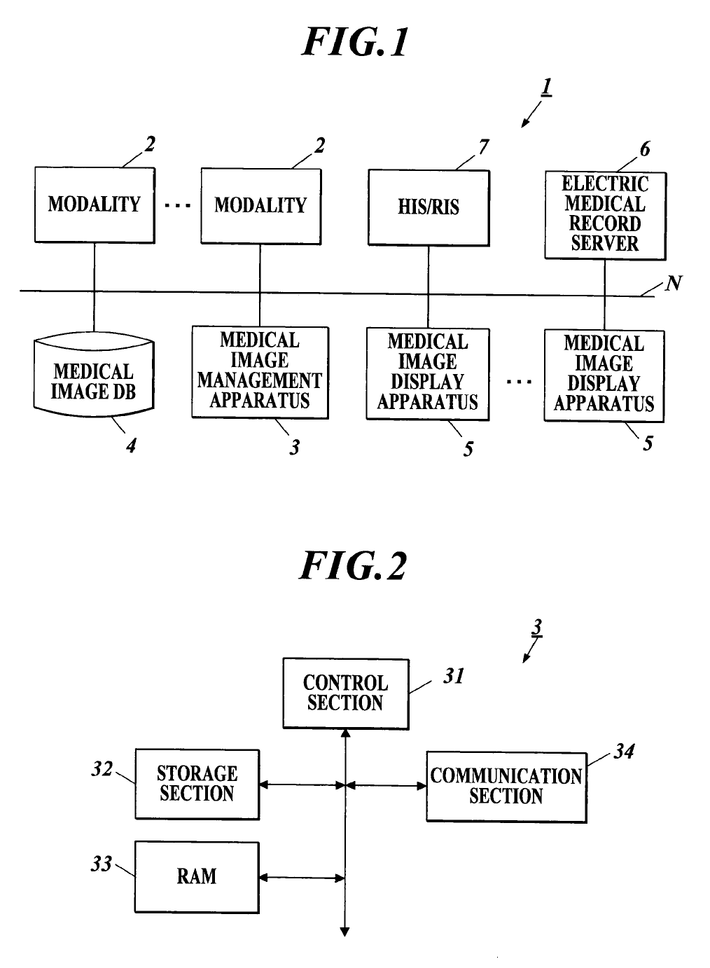

FIG. 1 shows a system configuration of a medical image display system 1 according to this embodiment.

The medical image display system 1 is configured to include a medical image management system and an electric medical record system. As shown in FIG. 1, the medical image management system is composed of a plurality of modalities 2, a medical image management apparatus 3, a medical image DB 4, and a plurality of medical image display apparatuses 5. The electric medical record system is composed of the plurality of medical image display apparatuses 5 and an electric medical record server 6. These constituent apparatuses in each of the systems are connected via a network N. The network N is Local Area Network (LAN) complying with Digital Imaging and Communication in Medicine (DICOM). The network N is configured so that the constituent apparatuses and other information management systems such as HIS/RIS 7 inside a hospital are connectable with each other.

HIS is short for Hospital Information System, and it is a hospital information system to collectively manage personal information of a patient, account processing of medical care costs, and so on. RIS is short for Radiology Information System, and it is a radiological department information system to consistently perform a reservation of a radiation examination and the like such as CR, an examination reception, an interpretation or storage of examination data, and so on.

The medical image display system 1 allows the electric medical record system which manages electric medical record data and the medical image management system which manages a series of various pieces of processing data from photographing to displaying of medical image to work in concert with each other so that the medical image display apparatus 5 displays a screen showing the electric medical record data and a screen showing the various pieces of processing data.

The medical image management system correlates: list data of a patient with respect to medical image data managed in the medical image management system; the medical image allowed to correspond to information of a patient photographed by the modality 2 and the examination; and also the various pieces of processing data such as examination report data of each of the medical image, with one another, to store these data and image in the medical image DB 4. The medical image management apparatus 3 manages an input/output of these data and image. By the control of the medical image management apparatus 3, the various pieces of processing data stored in the medical image DB 4 are output to the medical image display apparatus 5. Hereinafter, the constituent apparatuses will be explained.

The modality 2 is an image generating apparatus to photograph a patient to generate a photographic image (medical image) of the patient. As the modality 2, various apparatuses such as an X-ray photographic apparatus, Computed Tomography (CT) photographic apparatus, Magnetic Resonance Imaging (MRI) photographic apparatus, and ultrasonic wave/endoscope photographic apparatus may be cited. The photographed medical image is transmitted to the medical image DB 4. In the modality 2, information regarding the medical image which was obtained in photographing can be added to the medical image. As the information regarding the medical image, for example, patient information such as a patient ID for identifying a patient and a name and age of a patient, and examination information such as an examination date (photographing date), modality name, part name and photographing condition, image detailed information such as bit information of the medical image, and so on, may be cited. These pieces of information may be obtained as an input by a photographing operator in the modality 2, or as an input from an external apparatus.

The medical image management apparatus 3 collectively manages the various pieces of processing data stored in the medical image DB 4. FIG. 2 shows the configuration of the medical image management apparatus 3.

As shown in FIG. 2, the medical image management apparatus 3 is configured to include a control section 31, a storage section 32, a Random Access Memory (RAM) 33, a communication section 34 and the like.

The control section 31 is composed of a Central Processing Unit (CPU) and the like, and expands various control programs stored in the storage section 32 in RAM 33 to perform calculation in cooperation with these control programs, and to collectively control each of the sections 32-34.

The storage section 32 is composed of a Hard Disc (HDD) or semiconductor nonvolatile memory, and stores various control programs to be used in the control section 31, and also parameters, data and the like which are necessary for executing the program.

The RAM33 forms a work area for temporarily storing the various programs executable in the control section 31, which are read out from the storage section 32 in the various processing executed/controlled by the control section 31, input or output data, parameters, and so on.

The communication section 34 includes a communication interface such as a network interface card, and performs communication with the external apparatus on the network N. For example, the communication section 34 receives various signals transmitted from the medical image display apparatus 5 and transmits necessary data.

The medical image DB 4 is configured to include a large-capacity memory, and correlates the various pieces of processing data such as the list data of the patient, the medical image corresponding to the information of a patient photographed by the modality 2 and the examination, and the examination report data of each of the medical image, based on the patient information or the examination information, to store them. The medical image DB 4 outputs the instructed data to the instructed external apparatus according to the control of the medical image management apparatus 3.

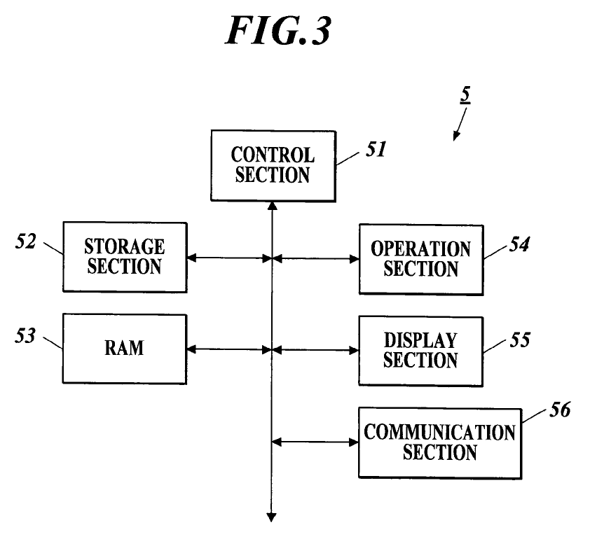

The medical image display apparatus 5 is used at the time of interpretation of the medical image, or medical examination work, by a doctor. The medical image display apparatus 5 is a terminal apparatus such as a Personal Computer (PC) which includes one or more monitors to display the subject data on the monitors. FIG. 3 shows the configuration of the medical image display apparatus 5.

As shown in FIG. 3, the medical image display apparatus 5 is configured to include: a control section 51; a storage section 52; a RAM 53; an operation section 54; a display section 55; a communication section 56; and also an image processing section, an image memory, and the like.

The control section 51 is configured to include a CPU and the like, reads out the various control programs stored in the storage section 52 to expand them in the RAM 53, and performs various calculations and the centralized control of each of the sections 52-56 in cooperation with these control programs.

The storage section 52 is composed of a Hard Disc (HDD) or a semiconductor nonvolatile memory, and stores the various control programs to be executed in the control section 51 as well as parameters, data, and the like which are necessary for executing the programs.

The RAM 53 forms a work area for temporarily storing the various programs which are executable in the control section 51 and read out from the storage section 52, an input or output data, a parameter, and the like, in the various processing executed/controlled by the control section 51.

The operation section 54 is configured to include a keyboard containing cursor keys, numeric input keys, various function keys and so on, and a pointing device such as a mouse. The operation section 54 outputs a depression signal of the key depressed on the keyboard or an operation signal by the mouse to the control section 51.

The display section 55 includes, for example, one or more monitors such as a Cathode Ray Tube (CRT) and a Liquid Crystal Display (LCD) to realize a function as a display member to display a screen showing the various processing data such as the medical image data and the report data, a screen showing the electric medical record data, and so on, on these monitors.

The communication section 56 includes a communication interface to perform a communication with the external apparatus on the network N. For example, the communication section 56 transmits request information for requesting the processing data such as the medical image to the medical image management apparatus 3, and receives the subject data from the medical image DB 4.

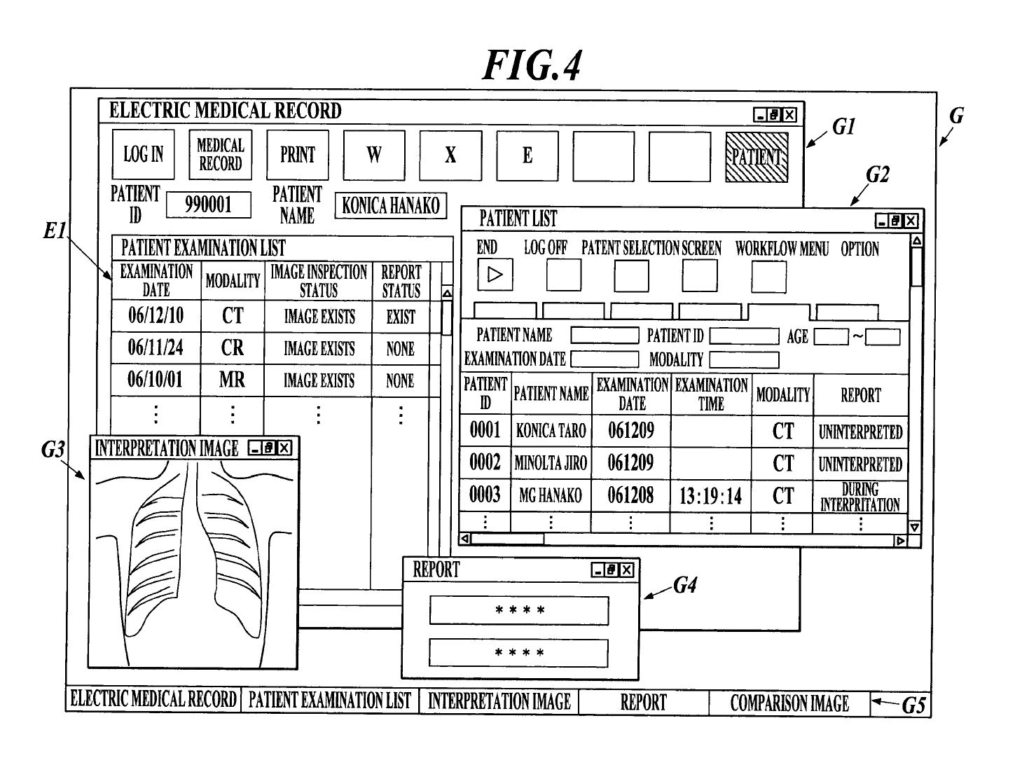

FIG. 4 shows various screen examples displayed on the monitor included in the display section 55.

As shown in FIG. 4, the monitor screen G can display: an electric medical record screen G1 to show the electric medical record data and to include after-mentioned patient examination list region E1; a patient list screen G2 to show the list data of a patient with regard to the medical image data managed in the medical image management system; an interpretation image screen G3 to show the medical image data with respect to the examination displayed in the patient examination list region E1; a report screen G4 to show the report data such as findings on the examination displayed in the patient examination list region E1; and a comparison image screen G5 to show a medical image data (older medical image data than the medical image on the interpretation image screen G3 in the same examination: hereinafter referred to as a comparison medical image data) to be compared with the interpretation image screen G3, thereon. In FIG. 4, the comparison image screen G5 is minimized.

The electric medical record screen G1 includes: a button for displaying a screen on which a user using the medical image display apparatus 5 logs in the electric medical record server 6; a button for activating various applications; the patient examination list region E1 to show the examination list data of the patient displayed on the electrical medical record screen G1; a text box (hereinafter a patient ID box) B11 in which a patient ID for identifying the patient corresponding to the electric medical record data displayed on the electric medical record screen G1 is input; and a display box in which the patient name corresponding to the patient ID is displayed.

In order to execute this embodiment, the electric medical record screen G1 includes a patient-related cooperation button B1 for allowing the electric medical record system and the list data of the patient stored in the medical image DB4 of the medical image management system to work in concert with each other to display the patient list screen G2.

The patient examination list region E1 is a region to display the examination list data of the patient corresponding to the patient ID based on the patient ID input in the patient ID box Bll displayed on the electric medical record screen G1. The patient examination list region E1 displays the examination date of a patient, a kind of the modality used on the examination date, existence or non-existence (an image inspection status) of the medical image by the modality, existence or non-existence (a report status) of the report with respect to the examination, and so on, in a list.

As the image inspection status, when the medical image exists, “IMAGE EXISTS” is displayed as hyper text in which location information of the medical image data photographed in the examination to be stored in the medical image DB 4 is embedded. When “IMAGE EXISTS” is selectively operated, it realizes a function to allow the examination for which “IMAGE EXISTS” is selectively operated with respect to a patient displayed on the electric medical record screen G1 and the medical image data of the examination of the patient to work in concert with each other.

As the report status, when the report exists, “EXIST” is displayed as hyper text in which location information of the report data of the examination stored in the medical image DB 4. When “EXIST” is selectively operated, it realizes a function to allow the examination for which “EXIST” is selectively operated with respect to a patient displayed on the electric medical record screen G1 and the report data of the examination to work in concert with each other.

The patient list screen G2 is a screen to be displayed when the patient-related cooperation button B1 contained in the electric medical record screen G1 is selected, for example, a basic screen when the medical image management system is executed.

The interpretation image screen G3 is a screen to be displayed when “IMAGE EXISTS” of the image inspection status with respect to any of the examinations in the examination list displayed in the patient examination list region E1 is selected.

The report screen G4 is a screen to be displayed when “EXIST” of the report status with respect to any of the examinations in the examination list displayed in the patient examination list region E1 is selected.

The comparison image screen G5 is a screen to be displayed when there is the medical image to be compared with the interpretation image screen G3 which is displayed when “IMAGE EXISTS” of the image inspection status with respect to any of the examinations in the examination list displayed in the patient examination list region E is selected.

Next, an operation of this embodiment will be described.

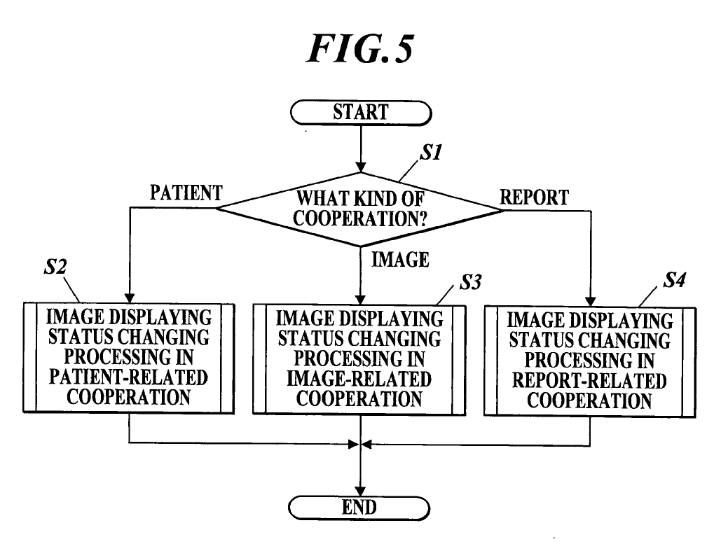

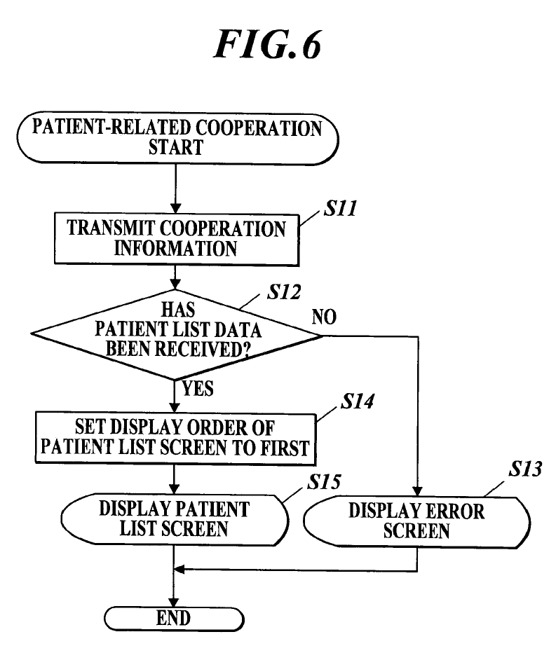

FIG. 5 shows a main flowchart of screen displaying status changing processing to be executed when allowing the electric medical record system and medical image management system of this embodiment to work in concert with each other. FIGS. 6, 7 and 8 show sub flowcharts.

The screen displaying status changing processing shown in FIGS. 5-8 is processing executed by software processing by cooperation between the control section 51 of the medical image display apparatus 5 and the processing program and various pieces of data stored in the storage section 52 or the program and various pieces of data downloaded from the storage section 32 of the medical image management apparatus 3 to be stored in the RAM 53. By executing this processing, a control member is implemented.

Firstly, the monitor constituting the display section 55 of the medical image display apparatus 5 displays at least the electric medical record screen G1.

The control section 51 of the medical image display apparatus 5 judges what kind of cooperative operation the electric medical record system and the medical image management system perform depending on operation contents on the displayed screen on the monitor of the display section 55 (Step S1).

The kind of cooperative operation is judged in Step S1, when the patient-related cooperation button B1 on the electric medical record screen G1 is selectively operated, as a patient-related cooperation to allow the electric medical record system and the list data of the patient stored in the medical image DB 4 of the medical image management system to work in concert with each other.

When “IMAGE EXISTS” as hyper text in the patient examination list region E1 is selectively operated, the kind of cooperative operation is judged as an image-related cooperation to allow the examination for which “IMAGE EXIST” of a patient displayed in the electric medical record screen G1 is selectively operated and the medical image data of the examination of the patient to work in concert with each other.

When “EXIST” as hyper text in the patient examination list region E1 is selectively operated, the kind of cooperative operation is judged as a patient-related cooperation to allow the examination for which “EXIST” of the patient displayed in the electric medical record screen G1 is selectively operated and the report data of the examination to work in concert with each other.

When the control section 51 of the medical image display apparatus 5 judges that the kind of cooperative operation is the patient-related cooperation (Step S1; patient), the screen displaying status changing processing in the patient-related cooperation (see FIG. 6) is executed (Step S2), and the processing ends.

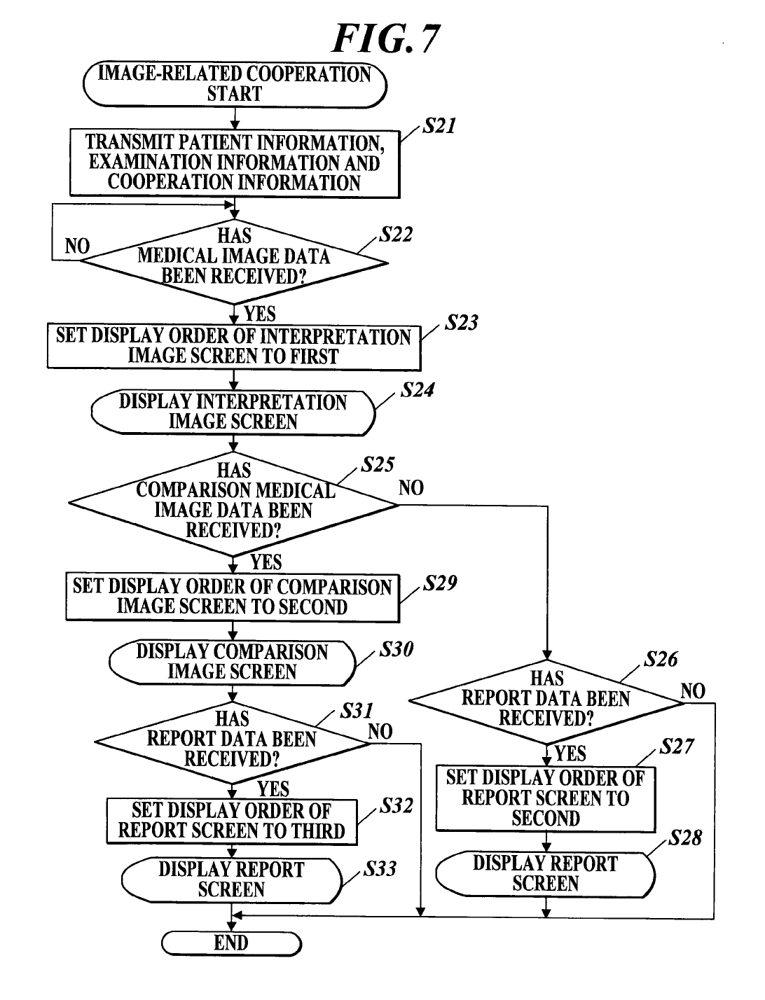

When the control section 51 of the medical image display apparatus 5 judges that the kind of cooperative operation is the image-related cooperation (Step S1; image), the screen displaying status changing processing in the image-related cooperation (see FIG. 7) is executed (Step S3), and the processing ends.

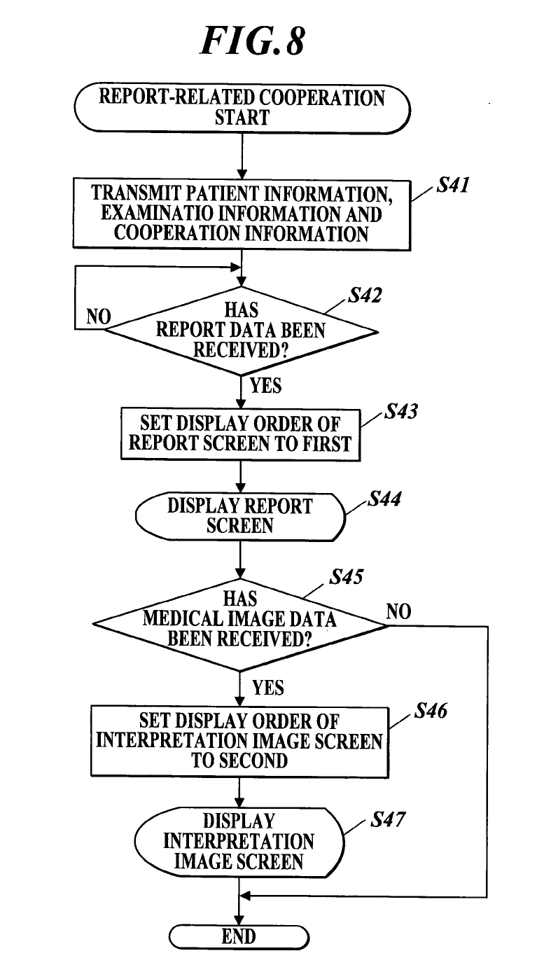

When the control section 51 of the medical image display apparatus 5 judges that the kind of cooperative operation is the report-related cooperation (Step S1; report), the screen displaying status changing processing in the report-related cooperation (see FIG. 8) is executed (Step S4), and the processing ends.

FIG. 6 shows the flowchart of the screen displaying status changing processing in the patient-related cooperation.

When the control section 51 of the medical image display apparatus 5 judges that the kind of cooperative operation is the patient-related cooperation (Step S1; patient-examination), information (cooperation information) indicating that it is the patient-related cooperation caused when the patient-related cooperation button B1 is selectively operated is transmitted to the medical image management apparatus 3 through the communication section 56 (Step S11).

When the medical image management section 3 receives the cooperation information from the medical image display apparatus 5 through the communication section 34, the control section 31 of the medical image management apparatus 3 reads out the list data of the patient from the medical image DB 4 to transmit the read list data of the patient to the medical image display apparatus 5 which transmitted the cooperation information.

The control section 51 of the medical image display apparatus 5 judges whether or not the list data of the patient has been received through the communication section 56 (Step S12), and when the list data of the patient has not been received (Step S12; No), an error screen informing that the list data of the patient does not exist is displayed on the monitor of the display section 55 (Step S13), and the processing ends.

When the control section 51 of the medical image display apparatus 5 has received the list data of the patient (Step S12; Yes), the display order of the patient list screen based on the received list data of the patient is set to be topmost (first) and front display status (pop-up) (Step S14).

In Step S14, with changing the display order of the patient list screen, the display order of the screen whose display order has been higher than the patient list screen among the various screens displayed on the monitor of the display section 55 is lowered by one (1) order.

The patient list screen is displayed according to the setting in Step 14 (Step S15), and the processing ends.

FIG. 7 shows a flowchart of the screen displaying status changing processing in the image-related cooperation.

When the control section 51 of the medical image display apparatus 5 judges that the kind of cooperative operation is the image-related cooperation (Step S1; image), the patient information (patient ID and the like) for identifying the patient displayed on the electric medical record screen G1, the examination information such as the examination date and the modality which corresponds to “IMAGE EXISTS” selectively operated on the patient examination list region E1, and information (cooperation information) indicating that it is the image-related cooperation caused by selectively operating “IMAGE EXISTS”, are transmitted to the medical image management apparatus 3 through the communication section 56 (Step S21).

In the medical image management apparatus 3, when the patient information, the examination information and the cooperation information are received through the communication section 34, the control section 31 of the medical image management apparatus 3 reads out the medical image data with respect to the examination of the patient based on the patient information and the examination information from the medical image DB 4. In addition, in the medical image management apparatus 3, the control section 31 retrieves the medical image data (comparison medical image data) with respect to the examination information whose examination date is older than that of the received examination information and which is identical to the received examination information except the examination date from the medical image DB 4. When there is the comparison medical image data, also the comparison medical image data is read out from the medical image DB 4. Then, the report data with respect to the examination of the patient based on the patient information and the examination information is retrieved from the medical image DB 4, and when there is the report data, also the report data is retrieved from the medical image DB 4.

The control section 31 of the medical image management apparatus 3 transmits the read medical image data, comparison medical image data or report data to the medical image display apparatus 5 which transmitted the patient information, examination information and cooperation information.

The control section 51 of the medical image display apparatus 5 judges whether or not the medical image data with respect to the examination of the patient displayed on the electric medical record screen G1 has been received through the communication section 56 (Step S22), and when the medical image data has not been received (Step S22; No), the processing returns to the Step S22.

When the control section 51 of the medical image display apparatus 5 has received the medical image data (Step S22; Yes), the display order of the interpretation image screen based on the received medical image data is set to be topmost (first) and front display status (pop-up) (Step S23), and the interpretation image screen is displayed according to the setting in the Step S23 (Step S24).

In Step S23, with changing the display order of the interpretation image screen, the display order of the screen whose display order has been higher than the interpretation image screen among the various screens displayed on the monitor of the display section 55 is lowered by one (1) order.

Moreover, the control section 51 of the medical image display apparatus 5 judges whether or not the comparison medical image data with respect to the medical image data of the examination of the patient displayed on the electric medical record screen G1 has been received through the communication section 56 (Step S25).

When the control section 51 of the medical image display apparatus 5 has not received the comparison medical image data (Step S25; No), it is judged whether or not the report data has been received (Step S26), and when the report data has not been received (Step S26; No), the processing ends.

When the control section 51 of the medical image display apparatus 5 has received the report data (Step S26; Yes), the display order of the report screen based on the report data is set to be immediately lower (second) than the interpretation image screen and front display status (pop-up) (Step S27), the report screen is displayed according to the setting in the Step S27 (Step S28), and the processing ends.

In Step S27, with changing the display order of the report screen, the display order of the screen (except the interpretation image screen) whose display order has been higher than the report screen among the various screens displayed on the monitor of the display section 55 is lowered by one (1) order.

When the control section 51 of the medical image display apparatus 5 has received the comparison medical image data (Step S25; Yes), the display order of the comparison image screen based on the comparison medical image data is set to be immediately lower (second) than the interpretation image screen and front display status (pop-up) (Step S29), and the comparison image screen is displayed according to the setting in the Step S29 (Step S30).

In Step S29, with changing the display order of the comparison image screen, the display order of the screen (except the interpretation image screen) whose display order has been higher than the comparison image screen among the various screens displayed on the monitor of the display section 55 is lowered by one (1) order.

Then, the control section 51 of the medical image display apparatus 5 judges whether or not the report data has been received (Step S31), and when the report data has not been received (Step S31; No), the processing ends.

When the control section 51 of the medical image display apparatus 5 has received the report data (Step S31; Yes), the display order of the report screen based on the report data is set to be immediately lower (third) than the comparison image screen and front display status (pop-up) (Step S32), the report screen is displayed according to the setting in the Step S32 (Step S33), and the processing ends.

In Step S32, with changing the display order of the report screen, the display order of the screen (except the interpretation image screen or the comparison image screen) whose display order has been higher than the report screen among the various screens displayed on the monitor of the display section 55 is lowered by one (1) order.

FIG. 8 shows a flowchart of the image displaying status changing processing in the report-related cooperation.

When the control section 51 of the medical image display apparatus 5 judges that the kind of cooperative operation is the report-related cooperation (Step S1; report), the patient information (the patient ID and the like) for identifying a patient displayed on the electric medical record screen G1, the examination information such as the examination data and the modality which corresponds to “EXIST” selectively operated in the patient examination list region E1, and the information indicating that it is the report-related cooperation caused when “EXIST” is selectively operated, are transmitted to the medical image management apparatus 3 through the communication section 56 (Step S41).

In the medical image management apparatus 3, when the patient information, the examination information and the cooperation information are received from the medical image display apparatus 5 through the communication section 34, the control section 31 of the medical image management apparatus 3 reads out the report data with respect to the examination of the patient based on the patient information and the examination information from the medical image DB 4. Also the medical image data with respect to the examination of the patient based on the patient information and the examination information is retrieved from the medical image DB 4, and when there is the medical image data, also the medical image data is read out from the medical image DB 4. The control section 31 of the medical image management apparatus 3 transmits the read report data or medical image data to the medical image display apparatus 5 which transmitted the patient information, examination information and cooperation information.

The control section 51 of the medical image display apparatus 5 judges whether or not the report data with respect to the examination of the patient displayed on the electric medical record screen G1 has been received through the communication section 56 (Step S42), and when the report data has not been received (Step S42; No), the processing returns to Step S42.

When the control section 51 of the medical image display apparatus 5 has received the report data (Step S42), the display order of the report screen based on the received report data is set to be topmost (first) and front display status (pop-up) (Step S43), and the report screen is displayed according to the setting in the Step S43 (Step S44).

In Step S43, with changing the display order of the report screen, the display order of the screen whose display order has been higher than the report screen among the various screens displayed on the monitor of the display section 55 is lowered by one (1) order.

Then, the control section 51 of the medical image display apparatus 5 judges whether or not the medical image data with respect to the examination of the patient displayed on the electric medical record screen G1 has been received through the communication section 56 (Step S45), and when the medical image data has not been received (Step S45; No), the processing ends.

When the control section 51 of the medical image display apparatus 5 has received the medical image data (Step S45; Yes), the display order of the interpretation image screen based on the received medical image data is set to be immediately lower (second) than the report screen and front display status (pop-up) (Step S46), the interpretation image screen is displayed according to the setting in the Step S46 (Step S47), and the processing ends.

In Step S46, with changing the display order of the interpretation image screen, the display order of the screen (except the report screen) whose display order has been higher than the interpretation image screen among the various screens displayed on the monitor of the display section 55 is lowered by one (I) order.

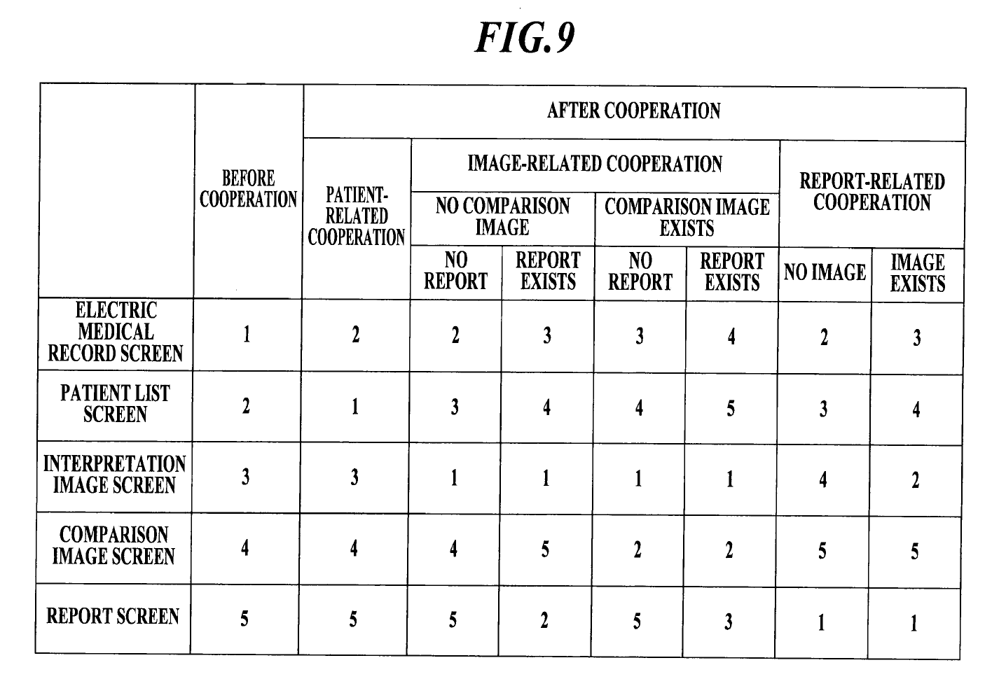

FIG. 9 shows an example of the screen display order depending on the kind of cooperative operation by executing the screen displaying status changing processing according to this embodiment.

As screens displayed on the monitor of the display section 55 of the medical image display apparatus 5, five screens: the electric medical record screen, the patient list screen, the interpretation image screen, the comparison image screen and the report screen are shown. As an example of the display order of the screens before the electric medical record system and the medical image management system shown in FIG. 9 work in concert with each other, the order is assumed such that the first is the electric medical record screen, the second is the patient list screen, the third is the interpretation image screen, the fourth is the comparison image screen, and the fifth is the report screen.

In the case of the patient-related cooperation, the display order of the patient list screen is changed to be topmost (first), and the display order of the electric medical record screen which has been higher than the patient list screen is lowered by one (1) order to be second.

In the case of the image-related cooperation and when neither the comparison image data nor the report data has been received, the display order of the interpretation image screen is changed to be topmost (first), and the display orders of the electric medical record screen and the patient list screen which have been higher than the interpretation image screen are lowered by one (1) order to be second and third.

In the case of the image-related cooperation and when the report data has been received, the display order of the interpretation image screen is changed to be topmost (first), the display order of the report screen is changed to be second, the display orders of the electric medical record screen and the patient list screen which have been higher than the interpretation image screen and report screen are lowered by two (2) order to be third and fourth, and the display order of the comparison image screen which has been higher than the report screen is lowered by one (1) order to be fifth.

In the case of the image-related cooperation and when the comparison medical image data has been received, the display order of the interpretation image screen is changed to be topmost (first), the display order of the comparison image screen is changed to be second, and the display orders of the electric medical record screen and the patient list screen which have been higher than the interpretation image screen and the comparison image screen are lowered by two (2) order to be third and fourth.

In the case of the image-related cooperation and when the comparison medical image data and the report data have been received, the display order of the interpretation image screen is changed to be topmost (first), the display order of the comparison image screen is changed to be second, the report screen is changed to be third, and the display orders of the electric medical record screen and the patient list screen which have been higher than the interpretation image screen, the comparison image screen and the report screen are lowered by three (3) orders to be fourth and fifth.

In the case of the report-related cooperation and when the medical image data has not been received, the display order of the report screen is changed to be topmost (first), and the display orders of the electric medical record screen, the patient screen, the interpretation image screen and the comparison image screen are lowered by one (1) order to be second, third, fourth and fifth.

In the case of the report-related cooperation and when the medical image data has been received, the display order of the report screen is changed to be topmost (first), the display order of the interpretation image screen is changed to be second, the display orders of the electric medical record screen and the patient list screen which have been higher than the report screen and the interpretation image screen are lowered by two (2) orders to be third and fourth, and the display order of the comparison image screen which has been higher than the report screen is lowered by one (1) order to be fifth.

This embodiment was explained in the case that the display order of the screen is: the interpretation image screen, the comparison image screen, and the report screen, from topmost screen, in the image-related cooperation, but the order of the comparison image screen and report screen may be reversed.

As described above, according to this embodiment, since the displaying status and the display order of the screen displayed in the display member can be changed depending on the kind of the cooperative operation between the electric medical record system and the medical image management system, the screens can be displayed in the priority order in accordance with the intended purpose. Thus, a trouble of switching/finding the screens by a user can be saved, and thereby convenience is enhanced.

Especially, in the case of the patient-related cooperation, since the patient list screen can be front-displayed in the topmost display order, a user can easily recognize that the patient list screen is displayed, and thereby convenience is enhanced.

In the case of the image-related cooperation, since the interpretation image screen of the examination of the patient indicated by the electric medical record data can be front-displayed in the topmost display order, a use can be easily recognize that the interpretation image screen of the examination of the patient is displayed, and thereby convenience is enhanced. Furthermore, the display order of the screen (comparison image screen) showing medical image data which is older than the medical image data of the interpretation image screen can be changed to be next to the order of the interpretation image screen and to be front-displayed. Thus, a user can easily find the interpretation image screen, and the comparison image screen to be compared with the interpretation image screen, and thereby the trouble of finding the necessary screen can be reduced.

In the case of the report-related cooperation, since the report screen of the examination of the patient indicated by the electric medical record data can be front-displayed in the topmost display order, a user can easily recognize that the report screen of the examination of the patient, and thereby convenience is enhanced.

The present invention is not limited to the above embodiment, and can be accordingly changed.

### INDUSTRIAL APPLICABILITY

The present invention can be used in the field where the electric medical record system and the medical image management system work in concert with each other.

### DESCRIPTION OF MARKS

1 medical image display system
2 modality
3 medical image management apparatus
4 medical image DB
5 medical image display apparatus
6 electric medical record server
7 HIS/RIS
31 control section
32 storage section
33 RAM
34 communication section
51 control section
52 storage section
53 RAM
54 operation section
55 display section
56 communication section
B1 patient-related cooperation button
B11 patient ID box
E1 patient examination list region
G monitor screen
G1 electric medical record screen
G2 patient list screen
G3 interpretation image screen
G4 report screen
G5 comparison image screen
N network

1. A medical image display system comprising:
a control member to allow an electric medical record system which manages electric medical record data and a medical image management system which manages a series of various pieces of processing data from photographing to displaying of a medical image to work in concert with each other; and
a display member to display a screen to show the electric medical record data and a screen to show the various pieces of processing data;
wherein the control member changes a displaying status and a display order of the screens displayed in the display member depending on a kind of cooperative operation between the electric medical record system and the medical image management system.

2. The medical image display system of claim 1, wherein
the various pieces of processing data includes list data of a patient with respect to the medical image which is managed in the medical image management system, and
the control member changes the display order of the screen showing the list data of the patient to be topmost and to be front-displayed when the kind of the cooperative operation is a kind which allows the electric medical record system and the list data of the patient included in the various pieces of processing data to work in concert with each other.

3. The medical image display system of claim 1, wherein
the various pieces of processing data include medical image data of each patient and each examination, and
the control member changes the display order of the screen showing the medical image data of the examination of the patient which the electric medical record data indicates to be topmost and to be front-displayed when the kind of the cooperative operation is a kind which allows the examination of the patient which the electric medical record data indicates and the medical mage data of the examination of the patient included in the various pieces of processing data to work in concert with each other.

4. The medical image display system of claim 3, wherein
the control member changes the display order of the screen showing the medical image data of the examination of the patient which the electric medical record data indicates to be topmost and to be front-displayed, and changes the display order of the screen showing older medical image data than the medical image data to be next to the order of the screen showing the medical image data and to be front-displayed, when the kind of the cooperative operation is a kind which allows the examination of the patient which the electric medical record data indicates and the medical image data of the examination of the patient included in the various pieces of processing data to work in concert with each other.

5. The medical image display system of claim 1, wherein
the various pieces of processing data include report data of each patient and each examination, and
the control member changes the display order of the screen showing the report data of the examination of the patient which the electric medical record data indicates to be topmost and to be front-displayed when the kind of cooperative operation is a kind which allows the examination of the patient which the electric medical record data indicates and the report data of the examination included in the various pieces of processing data to work in concert with each other.
